(19) United States
(12) Patent Application Publication
(10) Pub. No.: US 2013/0292523 A1
(43) Pub. Date: Nov. 7, 2013

(54) Display

(71) Applicants: Joel Moore, Lexington, MA (US); James William Reddick, III, Mustang, OK (US); Jessica Moreland, Columbus, OH (US); Christopher Trunek, Salt Lake City, UT (US); Joel Beebe, Columbus, OH (US)

(72) Inventors: Joel Moore, Lexington, MA (US); James William Reddick, III, Mustang, OK (US); Jessica Moreland, Columbus, OH (US); Christopher Trunek, Salt Lake City, UT (US); Joel Beebe, Columbus, OH (US)

(21) Appl. No.: 13/783,212

(22) Filed: Mar. 1, 2013

Related U.S. Application Data
(63) Continuation-in-part of application No. 13/082,188, filed on Apr. 7, 2011, now abandoned.
(60) Provisional application No. 61/321,756, filed on Apr. 7, 2010.

(51) Int. Cl. F16M 13/02; A47F 7/06

(52) U.S. Cl. CPC F16M 13/02; A47F 7/06
USPC 248/121; 248/309.4; 248/205.1; 248/231.9

(57) ABSTRACT

Devices having a magnet disposed thereon are disclosed. The devices are operatively configured for suspending and displaying articles, such as tags, signage, clothing, and baseball caps containing ferrous elements.

### CROSS-REFERENCE TO RELATED APPLICATIONS

This application is a continuation-in-part of U.S. application Ser. No. 13/082,188, filed on Apr. 7, 2011, which claims priority to U.S. Provisional Patent Application No. 61/321,756, filed on Apr. 7, 2010, each of which is incorporated by reference herein in its entirety.

### BACKGROUND

Numerous articles, including tags, signage, clothing, and baseball caps contain ferrous elements which may be attracted by magnets. Devices are disclosed for suspending such articles.

### SUMMARY

In one embodiment, a display apparatus is provided, the apparatus comprising: a body comprising a proximal end portion and a distal end portion; a magnet oriented on a ventrally-oriented face of the proximal end portion, wherein the magnet is sized and shaped to magnetically retain a ferrous pin at the apex of a cap or other article; and wherein the distal end portion is configured to be engaged to a structure.

In another embodiment, a display apparatus is provided, the apparatus comprising: a body comprising a proximal end portion and a distal end portion; a magnet oriented on a ventrally-oriented face of the proximal end portion, wherein the magnet is sized and shaped to magnetically retain a ferrous pin at the apex of a cap or other article; wherein the distal end portion comprises at least one ventral-facing contact point, at least one posterior-facing contact point, and at least one anterior-facing contact point; and wherein resting the posterior-facing contact point on a structure causes a rotational moment created by the mass of the body, which rotational moment causes the anterior-facing contact point and the posterior-facing contact point to engage the structure.

In another embodiment, a display apparatus for displaying hats having a ferrous element in the apex of the hat is provided, the apparatus comprising: a support; at least one magnet oriented on the support, wherein the at least one magnet comprises a size and shape to magnetically engage the ferrous element in a hat and releasably attach the hat to the support; and a base attached to the support, wherein the base is configured to provide a stable platform for the support and the hat attached to the at least one magnet.

### BRIEF DESCRIPTION OF THE DRAWINGS

The accompanying figures, which are incorporated in and constitute a part of the specification, illustrate various example apparatuses, systems, and methods, and are used merely to illustrate various example embodiments.

FIG. 1 illustrates an example arrangement of a display apparatus.

FIG. 2 illustrates an example arrangement of a display apparatus.

FIG. 3 illustrates an example arrangement of a display apparatus.

FIG. 4 illustrates an example arrangement of a display apparatus.

FIG. 5 illustrates an example arrangement of a display apparatus.

FIG. 6 illustrates an example arrangement of a display apparatus.

FIG. 7 illustrates an example arrangement of a display apparatus.

FIG. 8 illustrates an example arrangement of a display apparatus.

FIG. 9 illustrates an example arrangement of a display apparatus.

FIG. 10 illustrates an example arrangement of a display apparatus.

FIG. 11 illustrates an example arrangement of a display apparatus.

FIG. 12 illustrates an example arrangement of a display apparatus.

FIG. 13 illustrates an example arrangement of a display apparatus.

FIG. 14 illustrates an example arrangement of a display apparatus.

FIG. 15 illustrates an example arrangement of a display apparatus.

FIG. 16 illustrates an example arrangement of a display apparatus.

FIG. 17A illustrates an example arrangement of a display apparatus.

FIG. 17B illustrates an example arrangement of a display apparatus.

FIG. 17C illustrates an example arrangement of a display apparatus.

FIG. 18 illustrates an example arrangement of a display apparatus.

FIG. 19 illustrates an example arrangement of a display apparatus.

FIG. 20 illustrates an example arrangement of a display apparatus.

FIG. 21 illustrates an example arrangement of a display apparatus.

### DETAILED DESCRIPTION

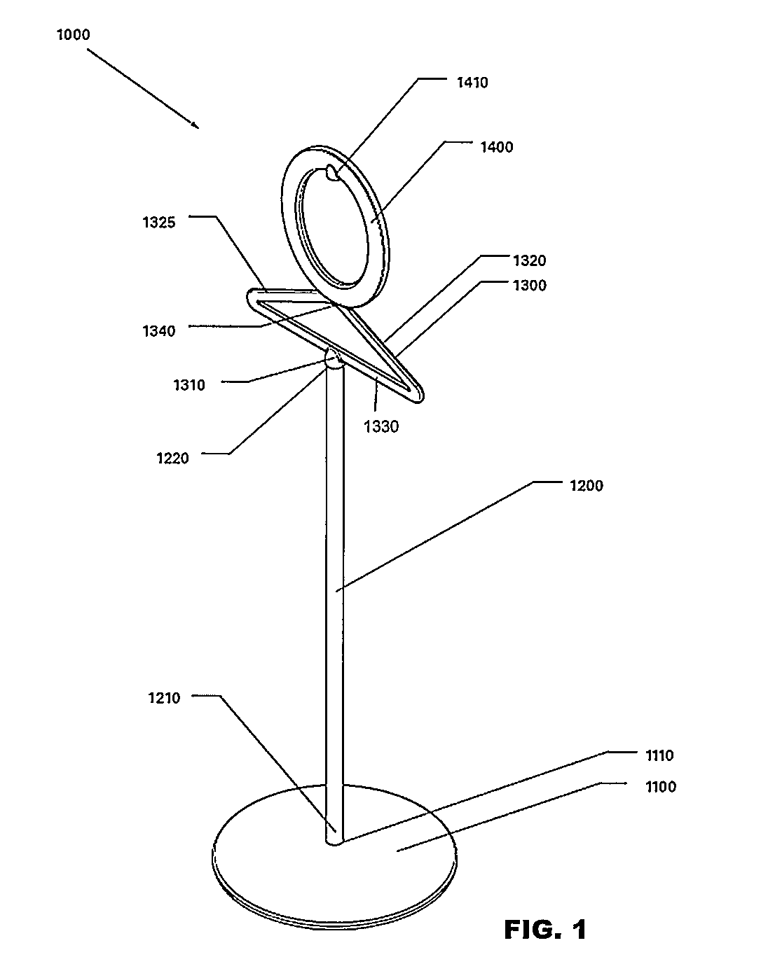

With reference to FIG. 1, a first embodiment of a hat rack 1000 is shown. Hat rack 1000 has a base 1100, a support 1200, a shoulder 1300, an annulus 1400, and a hat coupler 1410. Base 1100 is a substantially planar, discal member composed of substantially rigid material, including for instance a natural or synthetic resin or polymer, or a metal. According to further embodiments of the present disclosure not shown in the figures, base 1100 may further comprise an anchor weight portion made from a metal, sand, concrete, or other relatively dense material and molded, screwed, or adhered to base 1100, wherein the anchor weight portion lowers the center of gravity and stabilizes the assembled device. In one embodiment, base 1100 is configured to stabilize upon a floor, tabletop, or other planar surface. Although the embodiment of the present disclosure shown in the figures shows a circular and planar base member, there are further embodiments of the present disclosure wherein contact with a floor may be achieved by means of a non-planar and non-discal member, including for instance, a tripod, domed foot, or other foot structure.

There may be an aperture 1110 disposed centrally upon the dorsal face of base 1100, and operatively configured to receive and retain a complementary fitting 1210 of support 1200 therein. Although the assembly as shown in FIG. 1 is fitted by way of press-fitting, there are further embodiments of the present disclosure not shown in the figures wherein base 1100 and support 1200 are coupled by means of complimentary bayonet mounts, threads, adhesives, and other rigid coupling means known in the art. Although aperture 1110 is shown in the figures disposed centrally within base 1100, there are further embodiments of the present disclosure wherein aperture 1110 is oriented eccentrically within base 1100.

With continued reference to FIG. 1, support 1200 is a rigid elongated member have a substantially circular cross section composed substantially of a metal, natural polymer, or synthetic polymer. There are further embodiments of the present disclosure wherein the cross section of support 1200 approximates an annulus, a polygon having up to twenty sides, or a combination thereof. At the topmost portion of support 1200, there may be a fitting 1220 configured to be press fit within a receiver 1310 disposed upon a shoulder 1300. Although the assembly as shown in FIG. 1 is fitted by way of press-fitting, there are further embodiments of the present disclosure not shown in the figures wherein support 1200 and shoulder 1300 are coupled by means of complimentary bayonet mounts, threads, adhesives, and other rigid coupling means.

Shoulder 1300 may be a rigid member having slanted sides 1320 and 1325 extending in an obtuse angle away from a center point 1340 disposed dorsally and opening away from one another ventrally. The ventral portion of sides 1320 and 1325 may be joined by a crossbar 1330. Crossbar 1330 may be coupled to receiver 1310.

There may be an annulus 1400 coupled to shoulder 1300 near center point 1340. Annulus 1400 may be a rigid, substantially annular, substantially discal member having a hat coupler 1410 disposed upon the dorsal end portion of the inner circumference thereof. Hat coupler 1410 may comprise a magnetically active material configured to receive and retain the ferrous center pin of a hat or cap thereon. The magnetically active material of hat coupler 1410 may be a permanent magnet, a temporary magnet, or an electromagnet.

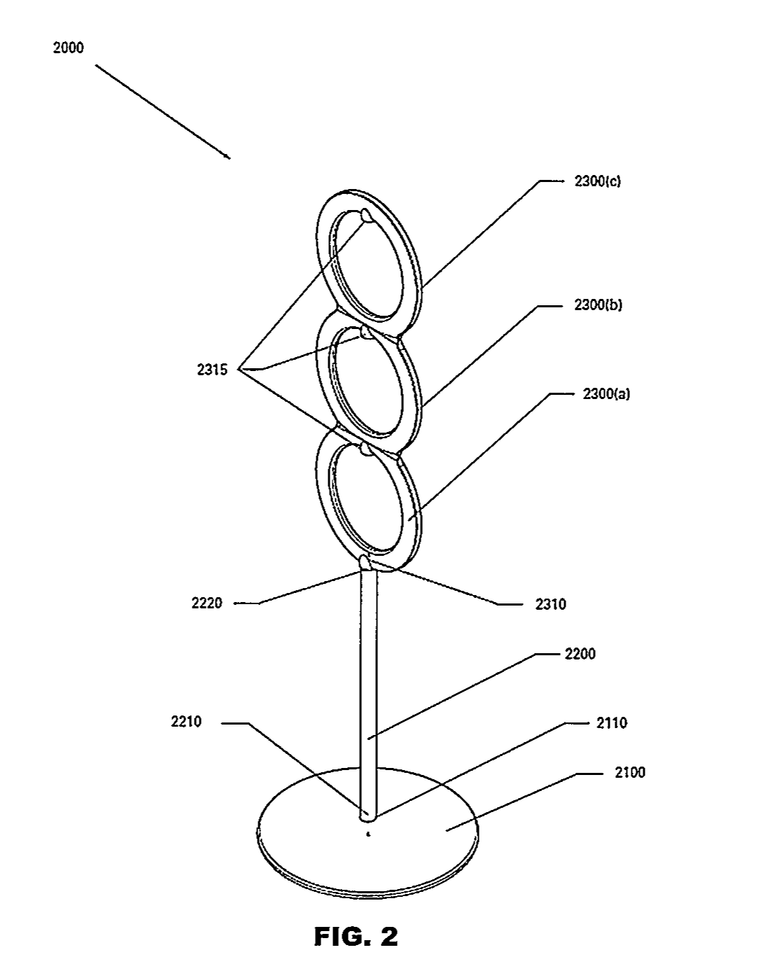

Referring now to FIG. 2, an embodiment of a hat rack 2000 is shown. As shown, hat rack 2000 has a base 2100, a support 2200, and annulae 2300(a-c). Base 2100 may be a substantially planar, discal member composed of substantially rigid material, including for instance a natural or synthetic resin or polymer, or a metal. According to further embodiments of the present disclosure not shown in the figures, base 2100 may further comprise an anchor weight portion made from a metal, sand, concrete, or other relatively dense material and molded, screwed, or adhered to base 2100, wherein the anchor weight portion lowers the center of gravity and stabilizes the assembled device. Although the embodiment of the present disclosure shown in the figures shows a circular and planar base member, there are further embodiments of the present disclosure wherein contact with a floor may be achieved by means of a non-planar and non-discal member, including for instance, a tripod, domed foot, or other foot structure known in the arts.

There is an aperture 2110 disposed centrally upon the dorsal face of base 2100, and operatively configured to receive and retain a complementary fitting 2210 of support 2200 therein. Although the assembly as shown in FIG. 2 is fitted by way of press-fitting, there are further embodiments of the present disclosure not shown in the figures wherein base 2100 and support 2200 are coupled by means of complimentary bayonet mounts, threads, adhesives, and other rigid coupling means known in the art. Although aperture 2110 is shown in the figures disposed centrally within base 2100, there are further embodiments of the present disclosure wherein aperture 2110 is oriented eccentrically within base 2100.

With continued reference to FIG. 2, support 2200 may be a rigid elongated member have a substantially circular cross section composed substantially of a metal, natural polymer, or synthetic polymer. There are further embodiments of the present disclosure wherein the cross section of support 2200 approximates an annulus, a polygon having up to twenty sides, or a combination thereof. At the topmost portion of support 2200, there may be a fitting 2220 configured to be press fit within a receiver 2310 disposed upon annulus 2300(a). Although the assembly as shown in FIG. 2 is fitted by way of press-fitting, there are further embodiments of the present disclosure not shown in the figures wherein support 2200 and annulus 2300(a) are coupled by means of complimentary bayonet mounts, threads, adhesives, and other rigid coupling means known in the art.

There are annulae 2300(a-c) coupled to support 2300. Annulae 2300(a-c) may be rigid, substantially annular, substantially discal members having a hat coupler 2315 disposed upon the dorsal end portion of the inner circumference thereof. Hat coupler 2315 may comprise a magnetically active material configured to receive and retain the ferrous center pin of a hat or cap thereon. The magnetically active material of hat coupler 2315 may be a permanent magnet, a temporary magnet, or an electromagnet.

With continued reference to FIG. 2, annulae 2300(a-c) may comprise a single, molded member. There are further embodiments of the present disclosure however wherein annulae 2300(a-c) are distinct members and able to be coupled to one another by way of press-fitting, snap-fitting, complimentary bayonet mounts, threads, adhesives, and other rigid coupling means.

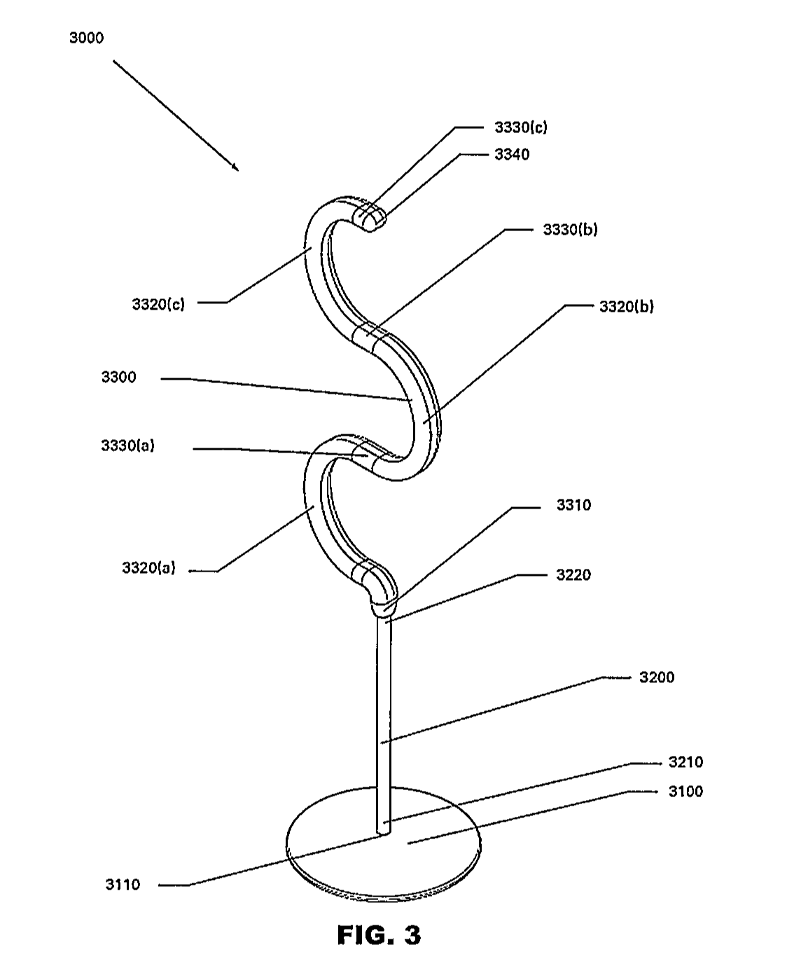

Referring now to FIG. 3, an embodiment of a hat rack 3000 is shown. Hat rack 3000 may have a base 3100, a support 3200, and an s-curve 3300. Base 3100 may be a substantially planar, discal member composed of substantially rigid material, including for instance a natural or synthetic resin or polymer, or a metal. According to further embodiments of the present disclosure not shown in the figures, base 3100 may further comprise an anchor weight portion made from a metal, sand, concrete, or other relatively dense material and molded, screwed, or adhered to base 3100, wherein the anchor weight portion lowers the center of gravity and consequently stabilizes the assembled device. Although the embodiment of the present disclosure shown in the figures shows a circular and planar base member, there are further embodiments of the present disclosure wherein contact with a floor may be achieved by means of a non-planar and non-discal member, including for instance, a tripod, domed foot, or other foot structure.

There may be an aperture 3110 disposed centrally upon the dorsal face of base 3100, and operatively configured to receive and retain a complementary fitting 3210 of support 3200 therein. Although the assembly as shown in FIG. 3 is fitted by way of press-fitting, there are further embodiments of the present disclosure not shown in the figures wherein base 3100 and support 3200 are coupled by means of complimentary bayonet mounts, threads, adhesives, and other rigid coupling means. Although aperture 3110 is shown in the figures disposed centrally within base 3100, there are further embodiments of the present disclosure wherein aperture 3110 is oriented eccentrically within base 3100.

With continued reference to FIG. 3, support 3200 may be a rigid elongated member have a substantially circular cross section composed substantially of a metal, natural polymer, or synthetic polymer. There are further embodiments of the present disclosure wherein the cross section of support 3200 approximates an annulus, a polygon having up to twenty sides, or combination thereof. At the topmost portion of support 3200, there may be a fitting 3220 configured to be press fit within a receiver 3310 disposed upon the s-curve 3300. Although the assembly as shown in FIG. 3 may be fitted by way of press-fitting, there are further embodiments of the present disclosure not shown in the figures wherein support 3200 and s-curve 3300 are coupled by means of complimentary bayonet mounts, threads, adhesives, and other rigid coupling means known in the art.

Referring still to FIG. 3, and proceeding from ventral to dorsal elements, s-curve 3300 may be comprised of receiver 3310, a c-curve 3320(a), coupler 3330(a), c-curve 3320(b), coupler 3330(b), c-curve 3320(c), coupler 3330(c), and end plug 3340.

C-curve 3320 may be a rigid arcuate member approximating half of a circle and configured to be rigidly coupled at adjacent structures at its dorsal and ventral ends by press-fitting. Although the assembly as shown in FIG. 3 is fitted by way of press-fitting, there are further embodiments of the present disclosure not shown in the figures wherein c-curve 3320 and its respective adjacent members are coupled by means of complimentary bayonet mounts, threads, adhesives, and other rigid coupling means known in the art.

Coupler 3330 may be a rigid member having a first and second end which are both configured to be press-fit into the respective dorsal and ventral ends of c-curve 3320. The ventral face of coupler 3330 may have a hat coupler (not shown) disposed thereupon. The hat coupler may comprise a magnetically active material configured to receive and retain the ferrous center pin of a hat or cap thereon. The magnetically active material of the hat coupler may be a permanent magnet, a temporary magnet, or an electromagnet.

End plug 3340 may be a domed member which is press-fit into the open end of coupler 3330(c) thereby terminating s-curve 3300.

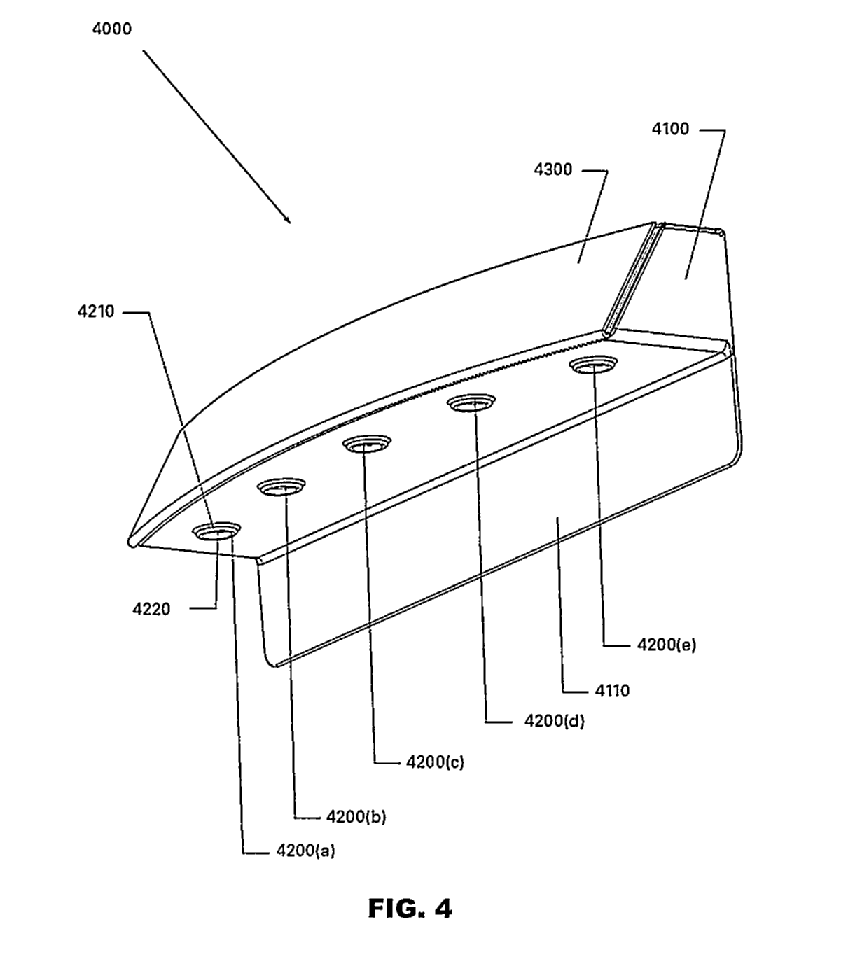

With reference to FIG. 4, a hat rack 4000 is shown having a body 4100 with a planar face 4110 extending ventrally from the posterior portion thereof, a plurality of couplers 4200(a-e) disposed on the ventral face of body 4100, and a display 4300 disposed on the anterior face of body 4100.

Body 4100 may be a rigid, elongated member having a quadrilateral cross-section and an anterior face which is arcuate and inclined dorsally. Body 4100 may be composed substantially of a natural or synthetic polymer, metal, or other rigid material known in the art. Face 4110 may be a substantially planar, substantially rectangular member extending ventrally from the posterior portion of body 4100. There may be a plurality of hat couplers 4200(a-e) disposed upon the ventral face of body 4100. Coupler 4200 may comprise a groove 4210 and a magnet 4220. Groove 4210 may be an annular member extending ventrally from the face of body 4100 and shaped to correspond to the ferrous center pin at the apex of a hat. Magnet 4220 may comprise a magnetically active material disposed within the center of groove 4210 and configured to receive and retain the ferrous center pin of a hat or cap thereagainst. The magnetically active material of hat coupler 4200 may be a permanent magnet, a temporary magnet, or an electromagnet.

Display 4300 may be a folded portion of transparent plastic, including for instance a polycarbonate or Lexan® molded to duplicate the curvature of the anterior face of body 4100 to which it is coupled by snap-fitting, hook-loop fastener, or adhesive. Display 4300 may be configured to receive and retain signage therein.

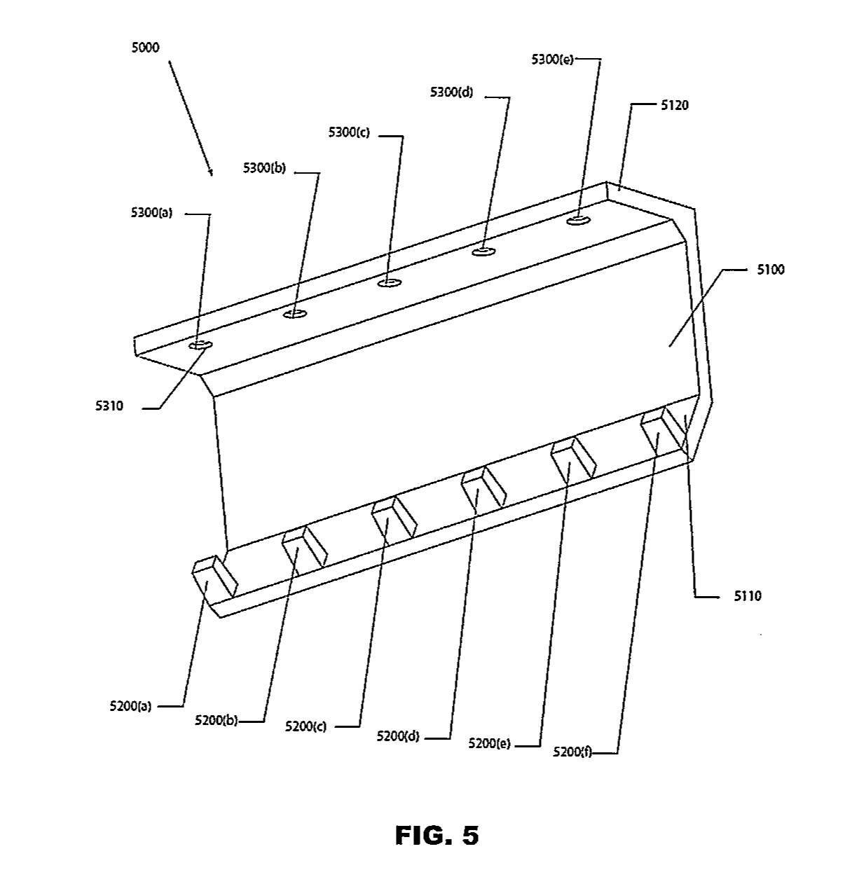

Referring now to FIG. 5, an embodiment of the present disclosure is shown. Rack 5000 may comprise a body 5100, hooks 5200(a-f), and couplers 5300(a-e). Body 5100 may be an elongated rigid member having a substantially c-shaped cross-section opening anteriorly. The posterior face of body 5100 may be configured to be fixed to a wall by means of screws, adhesives, snap-fittings, or nails disposed therein. There may be a ventral face 5110 extending at an obtuse angle from body 5100. There may be a plurality of hooks 5200(a-f) extending in substantially orthogonal relation to face 5110 and shaped for the hanging of clothing thereon.

There may be a dorsal shelf 5120 extending in substantially orthogonal relation from the dorsal portion of body 5100. There may be a plurality of couplers 5300(a-e) disposed upon the ventral face of shelf 5120. Coupler 5300 may be comprised of a magnet 5310 recessed into the surface of shelf 5120. The diameter of the recess within which coupler 5300 is disposed may be defined by the shape of a ferrous pin disposed upon the apex of a hat. Magnet 5310 may be a permanent magnet, a temporary magnet, or an electromagnet.

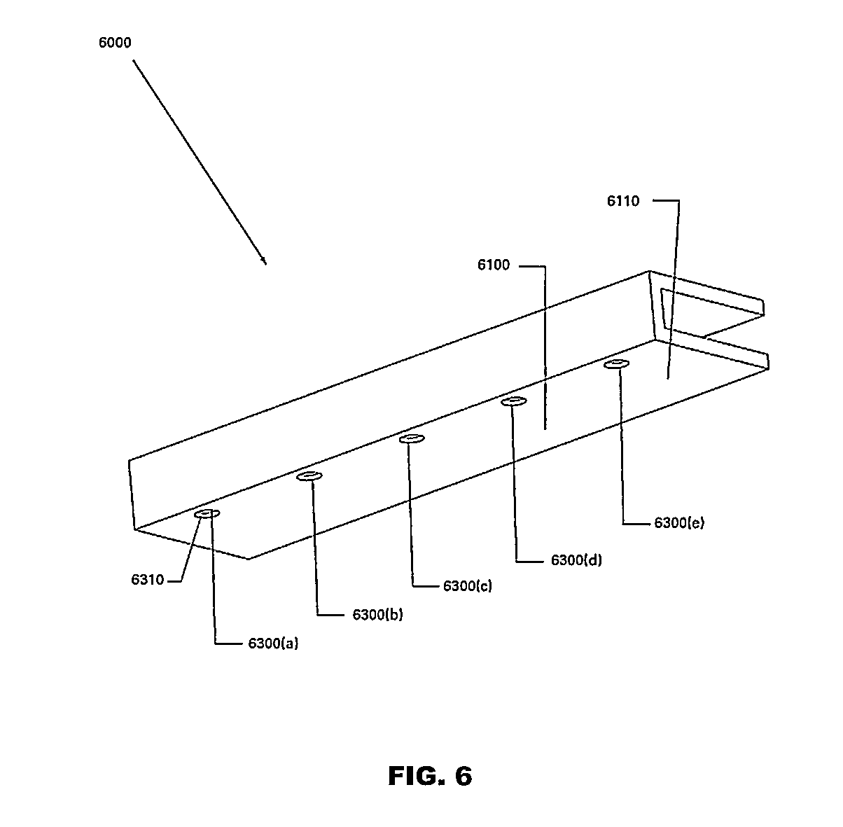

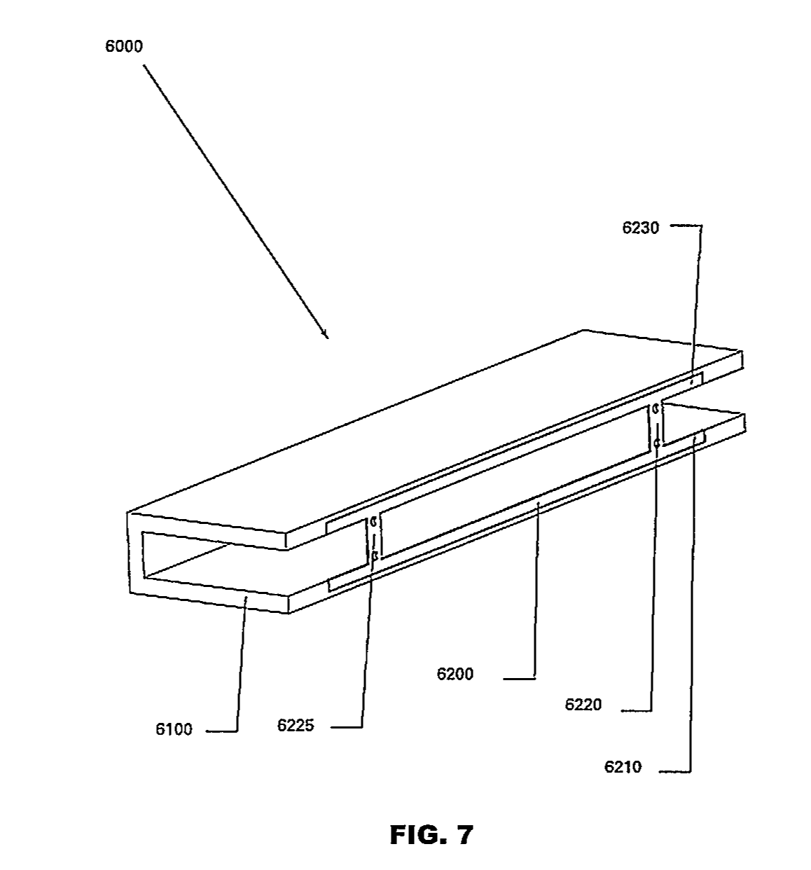

Referring now to FIGS. 6 and 7 together, an embodiment of the present disclosure is shown wherein a rack 6000 comprises a body 6100, a bracket 6200, and a plurality of couplers 6300(a-e). Body 6100 may be an elongated, substantially rigid member having a substantially c-shaped cross-section opening posteriorly. Body 6100 may have a ventral face 6110 having couplers 6300(a-e) disposed thereupon. Coupler 6300 may comprise a magnet 6310 recessed within a bore. The diameter of the recess within which coupler 6300 is disposed may be defined by the shape of a ferrous pin disposed upon the apex of a hat. Magnet 6310 may be a permanent magnet, a temporary magnet, or an electromagnet.

Referring now to FIG. 7, there may be a bracket 6220 having horizontal beams 6210 and 6230 coupled to the posterior face of body 6100. Further, bracket 6220 may have vertical beams 6220 and 6225 oriented in substantially orthogonal relation to horizontal beams 6210 and 6230. Vertical beams 6220 and 6225 may have apertures extending therethrough for coupling rack 6000 to a rigid structure, for instance, a wall.

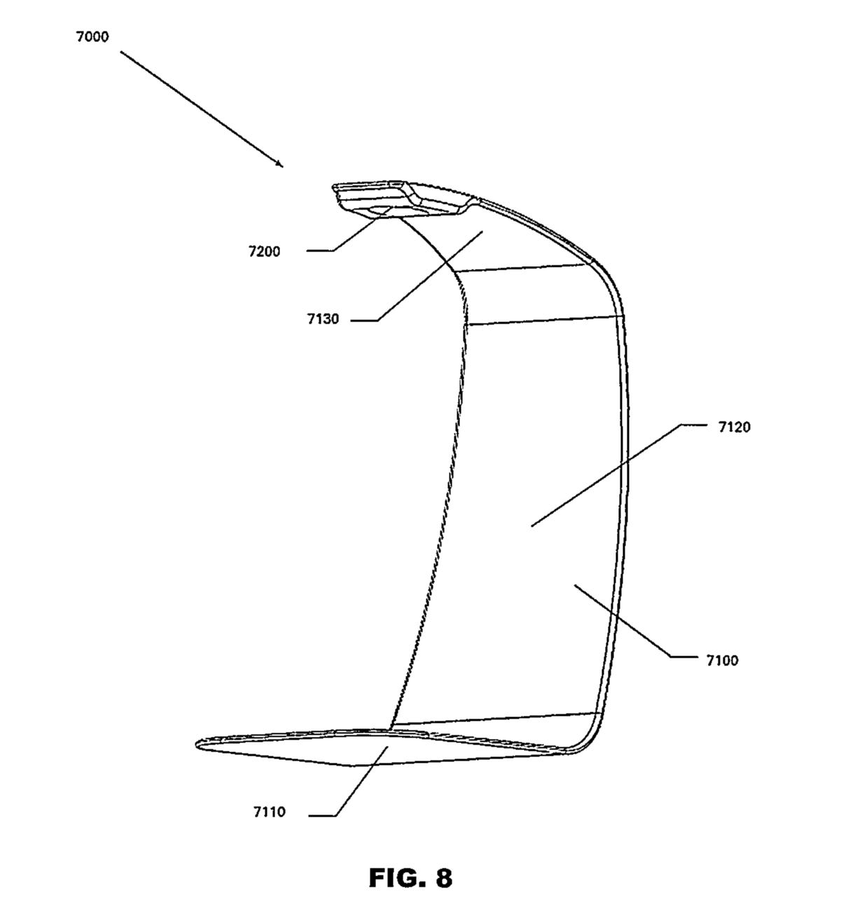

Referring now to FIG. 8, an embodiment of the present disclosure is shown. Rack 7000 comprises a body 7100 and a coupler 7200. Body 7100 is a curved member composed of a natural or synthetic polymer, metal, or laminations thereof approximating a c-shape with a foot portion 7110 at the ventral end thereof and a coupler 7200 at the dorsal end thereof. There is a magnet (not shown) disposed within coupler 7200 which is sized and shaped to magnetically retain the ferrous apex pin of a cap or other article thereagainst.

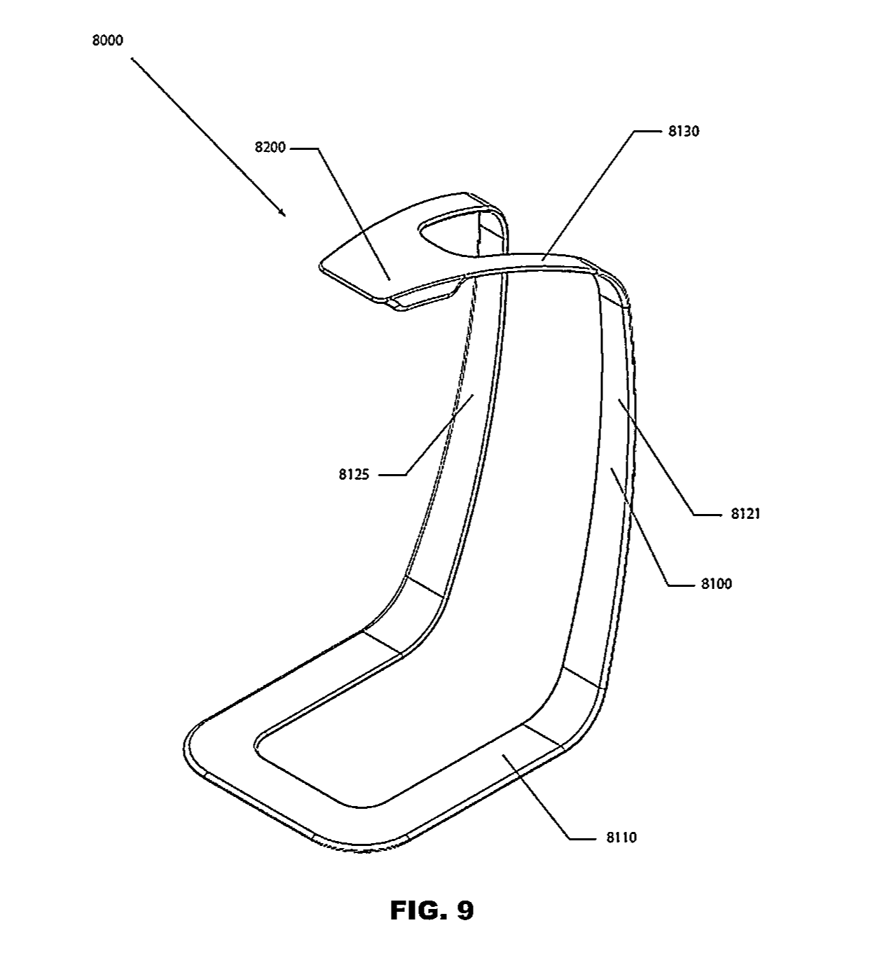

Referring now to FIG. 9, an embodiment of the present disclosure is shown. Rack 8000 comprises a body 8100 and a coupler 8200. Body 8100 is a curved member composed of a natural or synthetic polymer, metal, or laminations thereof approximating a c-shape with a foot portion 8110 at the ventral end thereof and a coupler 8200 at the dorsal end thereof. There is a portion removed from along the longitudinal axis of body 8100 thereby defining opposing arms 8121, 8125 and head 8130. There is a magnet (not shown) disposed within coupler 8200 which is sized and shaped to magnetically retain the ferrous apex pin of a cap or other article thereagainst.

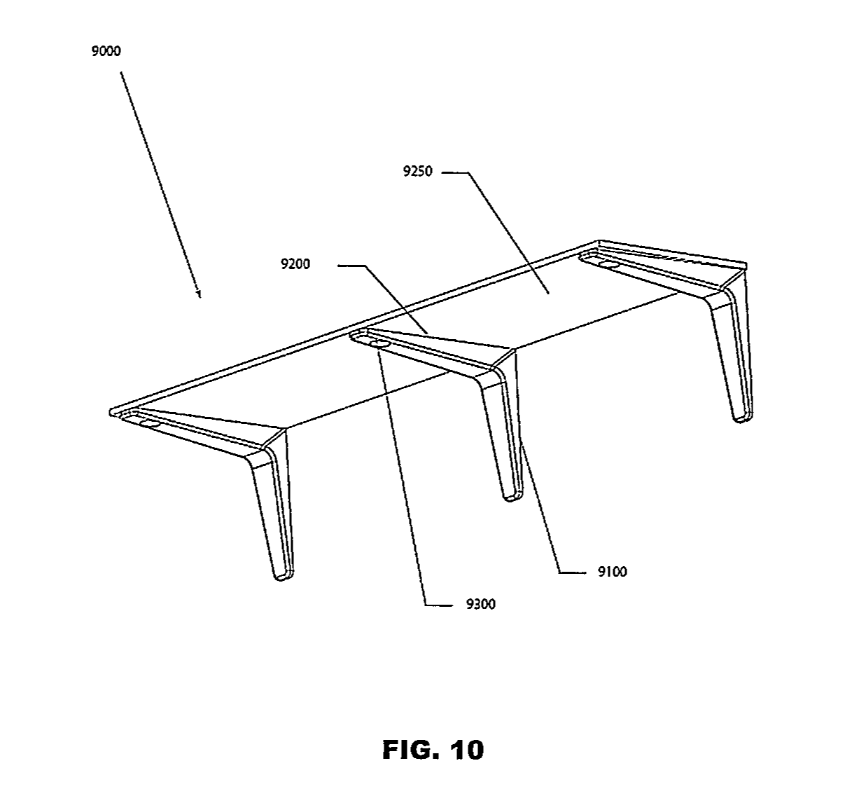

Referring now to FIG. 10, an embodiment of the present disclosure is shown. Rack 9000 comprises a right-angle bracket for supporting a shelf 9250 upon a dorsal face thereof, and a recessed magnet 9300 upon the ventral face thereof. Rack 9000 comprises an angled rigid member having a posterior face 9100 and a dorsal face 9200 at an orthogonal relation to one another.

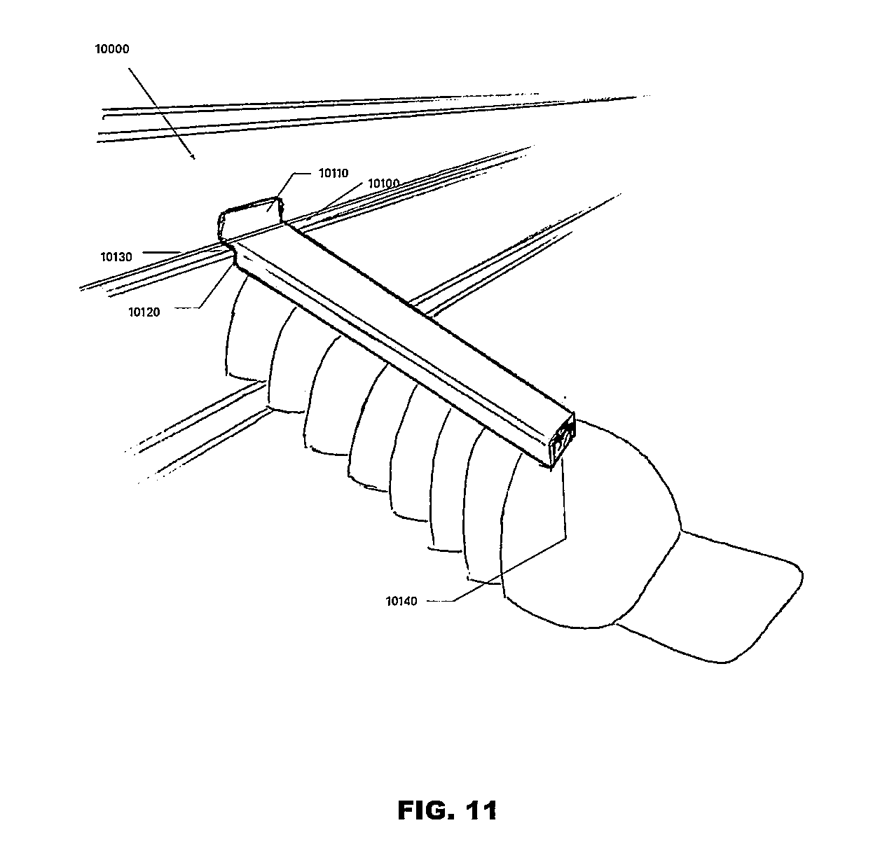

Referring now to FIG. 11, a display 10000 comprises an elongated body with a proximal end portion and a distal end portion. The distal end portion of display 10000 has a coupler 10100 disposed thereupon, itself further comprised of a substantially planar dorsal hook 10110 extending dorsally therefrom, a ventral face 10120 extending ventrally therefrom, and a thin spacer 10130 disposed therebetween. In one embodiment, the proximal end portion comprises an elongated, rigid member extending substantially proximally from the distal end portion. In another embodiment, the elongated member comprises at least one of: a molded integral body, a portion of bend metal or plastic, or a pair of elongated thin arms.

The proximal end portion of display 10000 is an elongated body having a ferromagnetic element 10140 disposed on a ventrally-oriented face thereof with sufficient holding force to retain the pin at the apex of one or more caps thereupon. Ferromagnetic element 10140 may be comprised of individual magnets spaced to accommodate multiple hats or a single, elongated magnet. In one embodiment, ferromagnetic element 10140 is sized and shaped to magnetically retain a ferrous pin at the apex of a cap or other article.

The distal end portion of display 10000 is sized and shaped such that it may be coupled to a free-standing structure such as a retail slot-board as shown in FIG. 11 or a peg-board by implementing a narrower hook 10110. Further, this configuration may be adapted for coupling to the top of a door or a cubicle divider by orienting the distal-most hook ventrally rather the dorsally. According to these embodiments, the display is held in place by means of gravity and in certain embodiments the rotational moment imparted by the mass of the proximal end of the proximal end portion of the device as shown in FIG. 11.

In one embodiment, the distal end portion of display 10000 comprises a coupler 10100 having a substantially horizontal face 10130 and two substantially parallel faces 10110 and 10120 extending from horizontal face 10130, wherein resting horizontal face 10130 upon a structure causes a rotational moment created by the mass of the proximal end portion of the body, and wherein the rotational moment causes the parallel faces 10110 and 10120 to engage the structure.

In another embodiment, the distal end portion of display 10000 comprises ventral face 10120, dorsal hook 10110, and thin spacer 10130 operatively connecting ventral face 10120 to dorsal hook 10110, and wherein resting thin spacer 10130 upon a structure, the mass of the body of display 10000 causes the anterior-facing portion of dorsal hook 10110 and the posterior-facing portion of ventral face 10120 to engage the structure.

In another embodiment, the distal end portion of display 10000 comprises an aperture sized and shaped to be retained against a screw or nail.

In another embodiment, display 10000 comprises a plurality of ferromagnetic elements 10140 operatively connected to a plurality of ventral-facing contact points, posterior-facing contact points, and anterior-facing contact points.

In one embodiment, display 10000 comprises a material (not shown) disposed between a surface of ferromagnetic element 10140 and the ferrous pin at the apex of a cap, which material provides a decreased coefficient of friction between the surface of ferromagnetic element 10140 and the ferrous pin. In one embodiment, the material is comprised of at least one of a polymer or a metal.

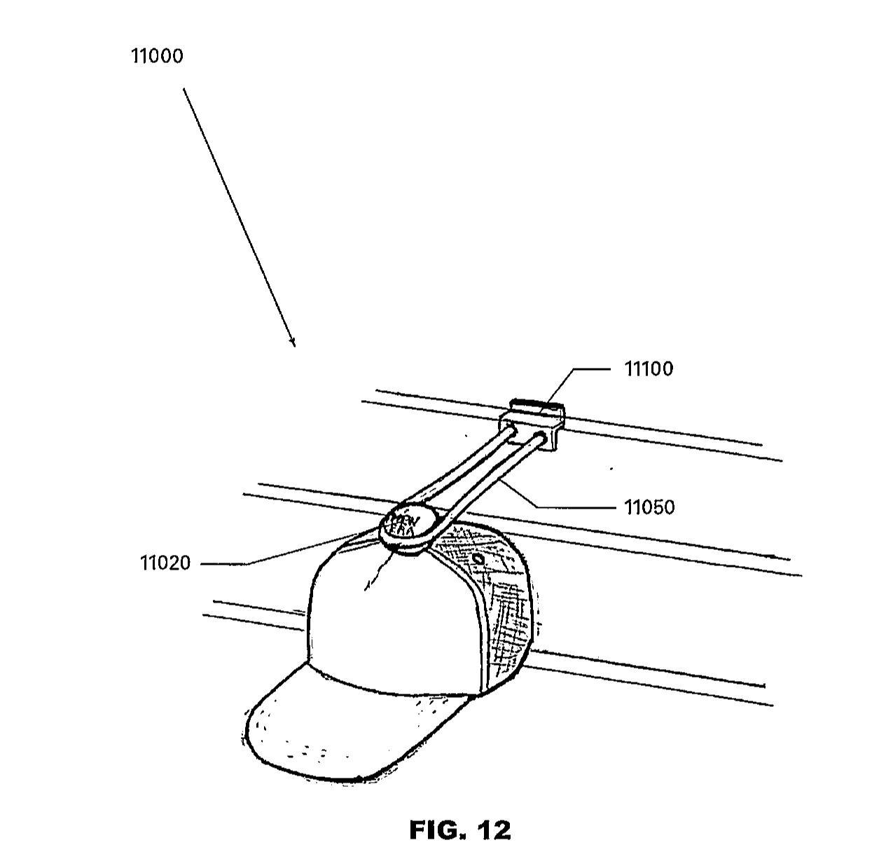

Referring now to FIG. 12, a further embodiment of a display 11000 is shown, wherein the ferromagnetic element 11020 is disposed upon a thin armature 11050 extending proximally from a coupler 11100 having features similar to coupler 10100.

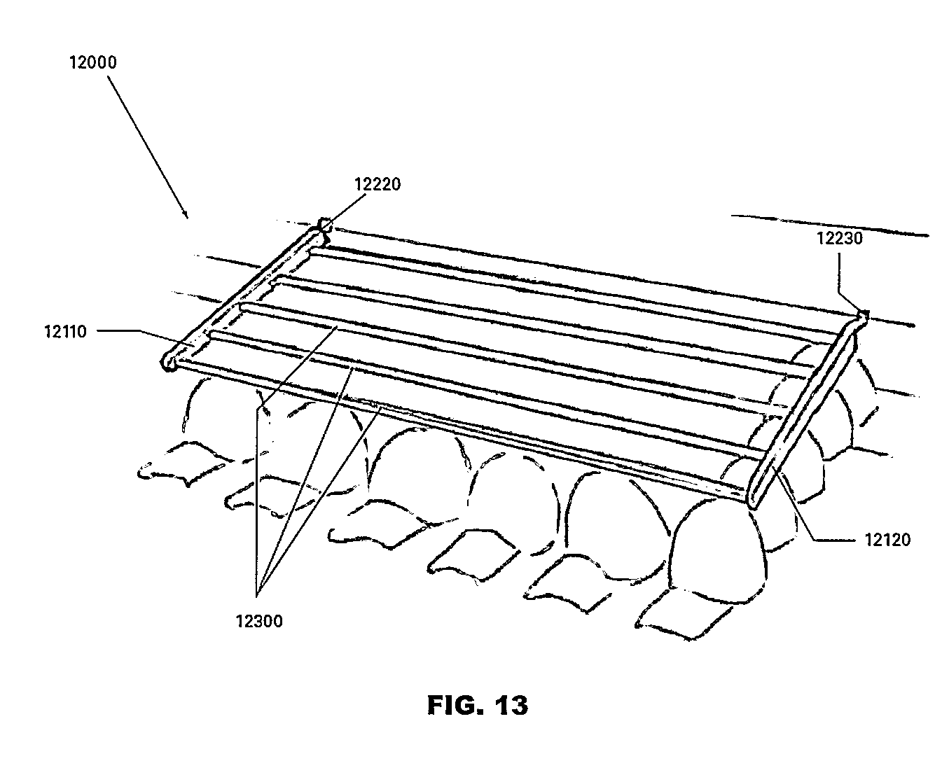

Referring now to FIG. 13, a further embodiment of a display 12000 is shown, having a pair of lateral beams 12110 and 12120 extending proximally from distal couplers 12220 and 12230. Couplers 12220 and 12230 have structures and function substantially similar to that of coupler 10100. There is a network of lateral supports 12300 disposed between beams 12110 and 12120 defining a plurality of ventral-facing points on the underside thereof whereabout magnetic elements for retaining caps are disposed as shown in FIG. 13.

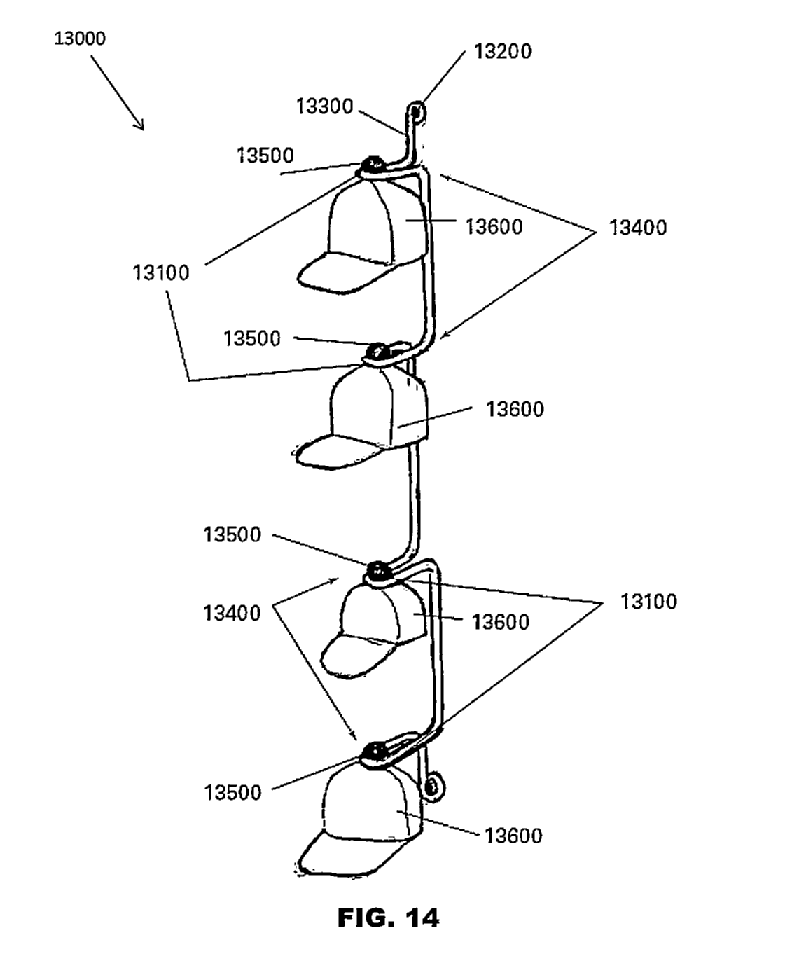

Referring now to FIG. 14, a further embodiment of a display 13000 is shown wherein display 13000 comprises a plurality of elongated links 13100 beginning with a cephalic-end loop 13200 engaged about a screw or nail to a structure such as a door or wall. There is an elongated member 13300 extending ventrally from loop 13200 which in turn terminates with a proximally-extending extrusion 13400. Proximally-extending protrusion 13400 has upon at its proximal-end ventral face a magnet 13500 for retaining a cap 13600 thereagainst, and at its distal-end ventral face a next ventrally extending body, thereby providing for the preceding structures to repeat, thereby providing for the support of multiple caps 13600.

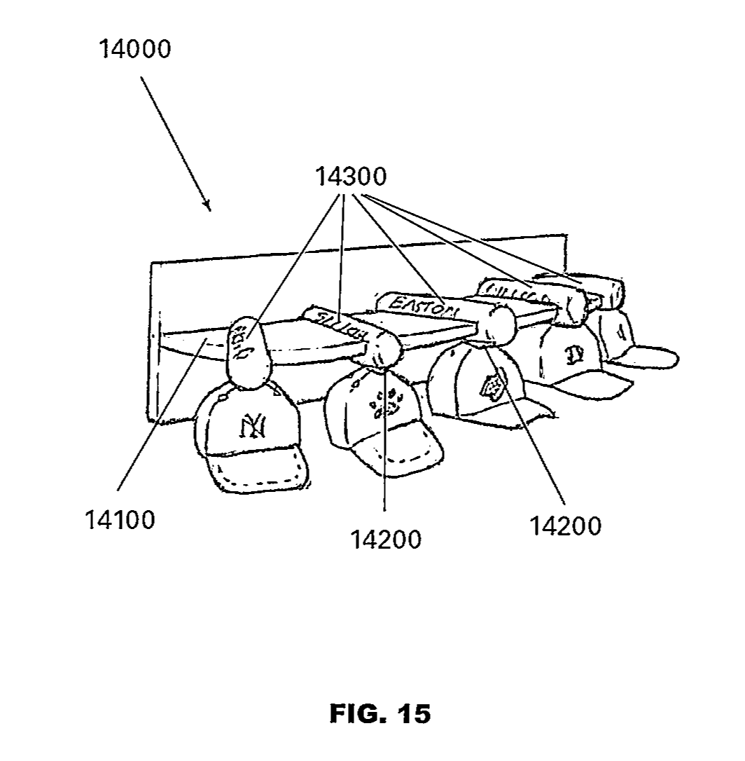

Referring now to FIG. 15, a further embodiment of a display 14000 is shown wherein display 14000 comprises a horizontal shelf 14100 having a plurality of magnets 14200 disposed upon a ventral face thereof sized and shaped to retain a hat pin thereagainst. Display 14000 further comprises a plurality decorative cylinders 14300 disposed thereupon sized and shaped to aesthetically approximate baseball bats.

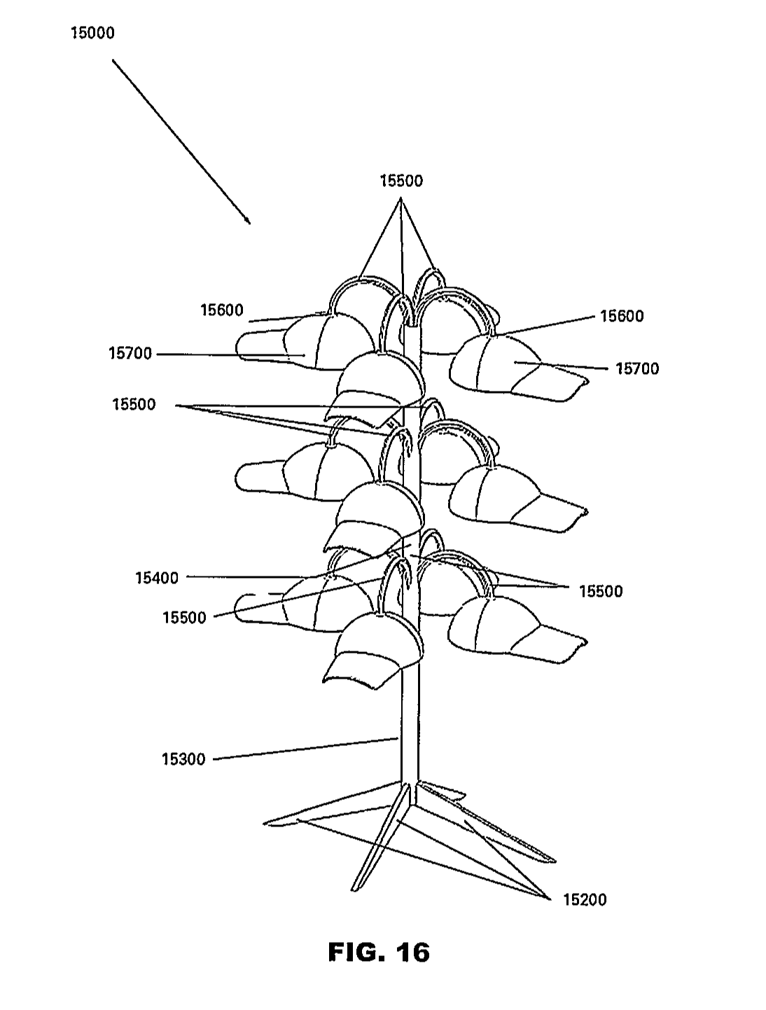

Referring now to FIG. 16, a further embodiment of a display 15000 is shown comprising a ventral base 15100 having a plurality of feet 15200 extending laterally and ventrally from a common first origin to the ground or floor below thereby providing operative support for the structures disposed thereabove. There is an elongated, substantially rigid member 15300 extending cephalically from the first origin. Further, there is at least one point 15400 disposed cephalically from the origin along elongated rigid member 15300 with a second origin from which a plurality of arcuate members 15500 medially extend. At the medial ends of arcuate members 15500, there are magnets 15600 sized and shaped to retain the metallic pin of a cap 15700 thereagainst.

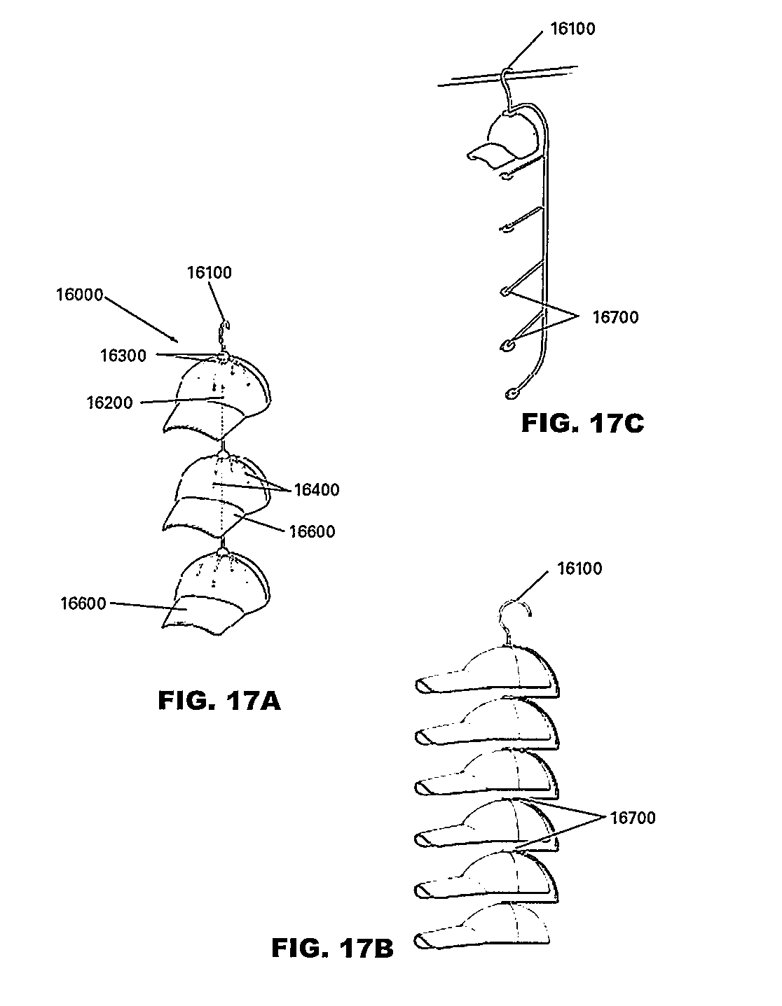

Referring now to FIG. 17A, a further embodiment 16000 of a display is shown, wherein display 16000 is comprised of a hook portion 16100 and at least one hat spreader portion 16200. Hook portion 16100 is an elongated member having a hook disposed at the cephalic end thereof and a magnet 16300 disposed at the ventral end thereof. A hat spreader 16200 is comprised of a first cephalically oriented magnet 16300 and a second ventrally-oriented magnet 16300. There are optionally a plurality of arcuate arms 16400 extending from the area near first magnet 16300 sized and shaped to maintain the curvature and volume of a cap 16600. Although arms 16400 are shown in the figure as being distinct members, there are further embodiments of the present disclosure wherein the volume of a hat 16600 is maintained by one or more enlarged and curved integral pieces.

Upon assembly of display 16000 as shown in FIG. 17A, the device is arranged as a hook portion 16100 suspended from a structure (not shown), a hat 16600 coupled by the ventral magnet 16300 of the hook portion 16100, and a spreader 16200 coupled to the underside of hat 16600. The ventral-end magnet 16300 of spreader 16200 provides a point for attaching further hats 16600 and thereby iteratively repeating the assembly.

Referring now to FIGS. 17B and 17C, further embodiments of the present disclosure are shown wherein structures similar to those described in the preceding description are suspended from a hook 16100 by means of various armatures 16700. In one embodiment, hook 16100 is configured to attach to a closet clothing rod.

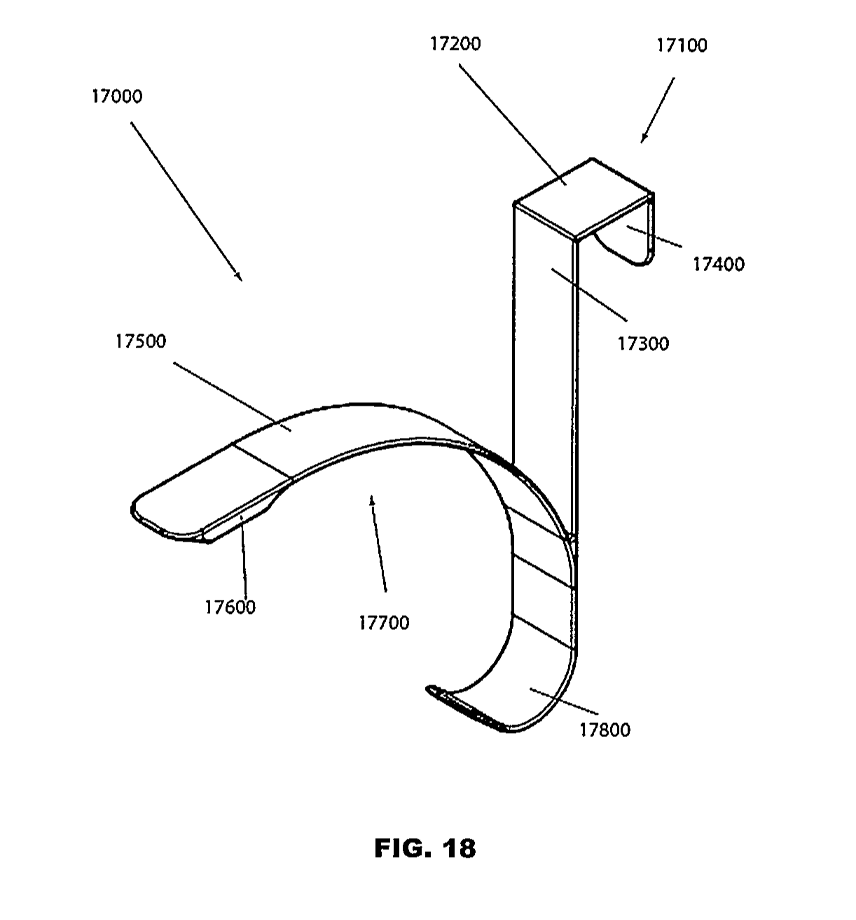

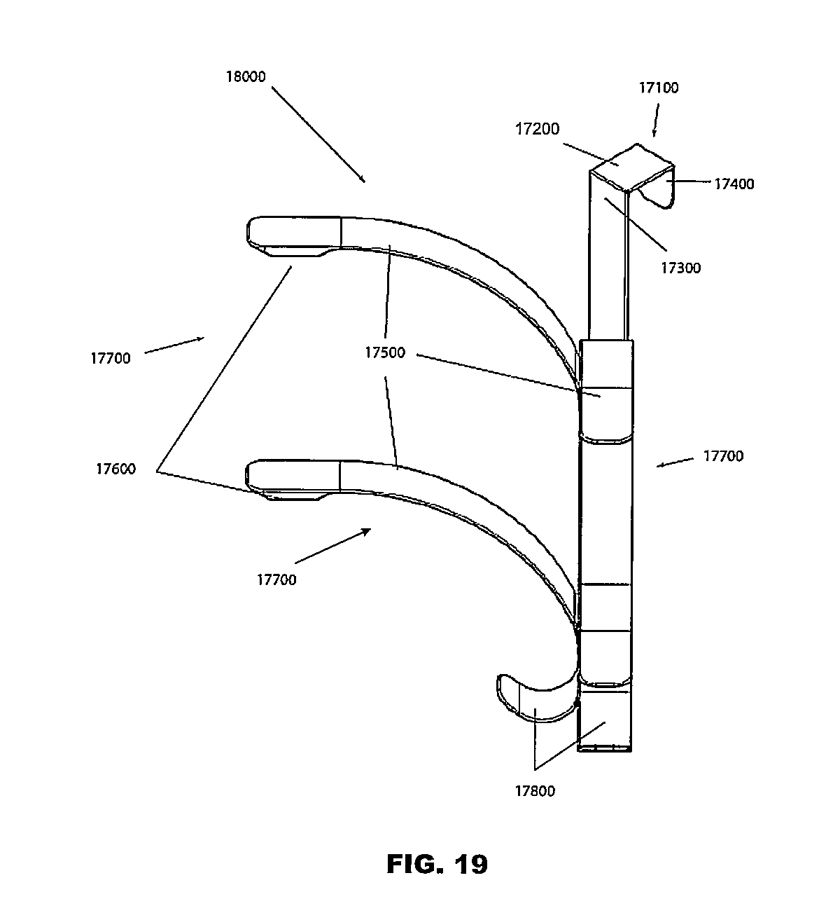

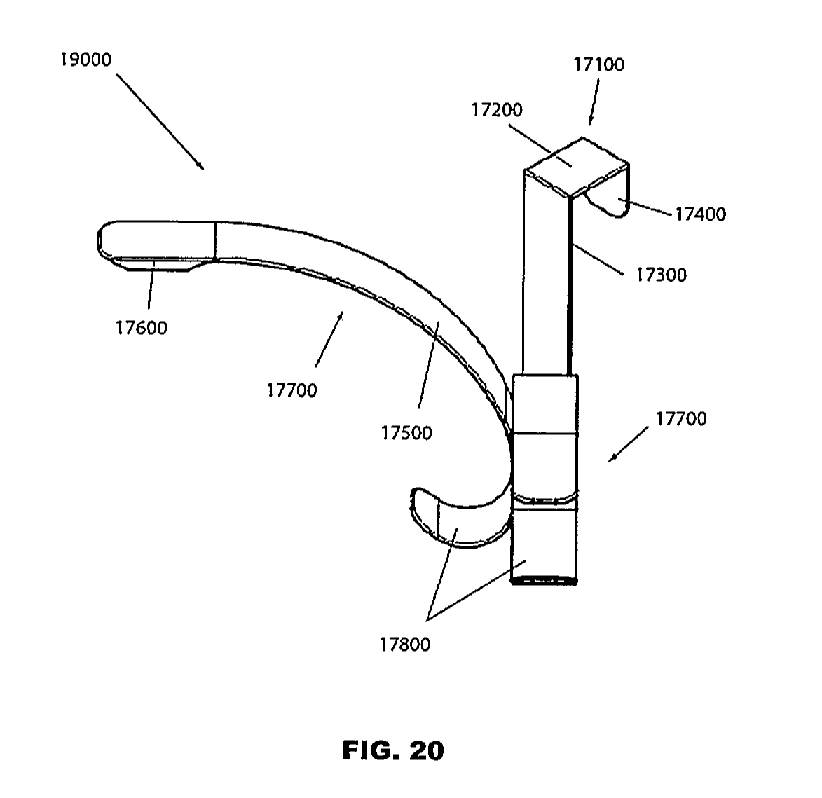

Referring now to FIGS. 18, 19, and 20 together, further embodiments a display 17000, 18000, and 19000 are shown having a posterior facing portion 17100 having at least a ventral-facing contact point 17200 with at least one posterior-facing contact point 17300 and at least one anterior-facing contact point 17400 disposed upon opposing sides thereof and a vertical offset therefrom thereby defining a mount. There is a protrusion 17500 extending proximally therefrom having a magnet 17600 on a ventral facing portion thereof sized and shaped to retain the ferrous pin at the apex of a cap thereagainst defining a hat holder 17700. According to the embodiments shown in the figures, there may also be hooks 17800 disposed ventrally from hat holder 17700 sized and shaped to engage upon clothing items, keys, or other items capable of being supported in such a manner. Further still, according to further embodiments of the present disclosure exemplified by FIGS. 19 and 20, each given mount may provide operative support for multiple hat hooks 17700.

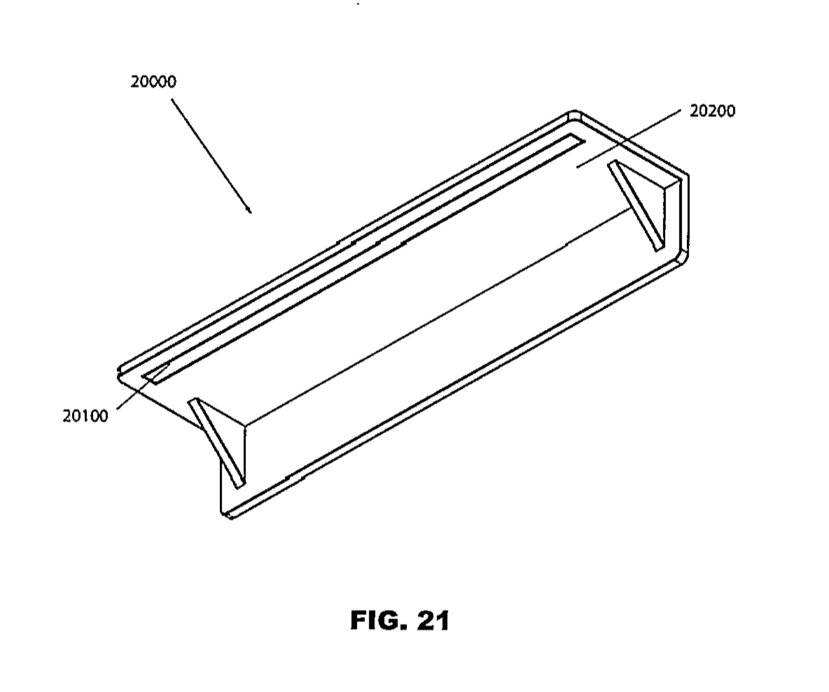

Referring now to FIG. 21, a further embodiment of a display 20000 is shown having an elongated magnet 20100 disposed on the ventral-facing portion 20200 thereof.

A method of using the various embodiments will now be described. For instance, with reference to rack 1000, rack 1000 is provided in a first state, having no articles attached thereto. Next, an operator may use rack 1000 by holding a ferrous object, including for instance the apex pin of a baseball cap, sufficiently close to hat coupler 1410 such that the magnetic attractive force between hat coupler 1410 and the pin is sufficient to overcome gravitational force urging the hat to fall. Next, an operator removes their hand and the hat remains in place. When an operator wishes to separate the hat from hat coupler 1410, he applies sufficient force thereto to overcome the magnetic attraction.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A display apparatus, the apparatus comprising:
a body comprising a proximal end portion and a distal end portion;
a magnet oriented on a ventrally-oriented face of the proximal end portion,
wherein the magnet is sized and shaped to magnetically retain a ferrous pin at the apex of a cap or other article; and
wherein the distal end portion is configured to be engaged to a structure.

2. The apparatus of claim 1, wherein the distal end portion comprises a substantially horizontal face and two substantially parallel faces extending from the horizontal face, wherein resting the horizontal face upon a structure causes a rotational moment created by the mass of the proximal end portion of the body, and wherein the rotational moment causes the parallel faces to engage the structure.

3. The apparatus of claim 1, wherein the distal end portion comprises a ventral face, a dorsal hook, and a thin spacer operatively connecting the ventral face to the dorsal hook, and wherein resting the thin spacer upon the structure causes a rotation moment created by the mass of the body, which rotational moment causes the anterior-facing portion of the dorsal hook and the posterior-facing portion of the ventral face to engage the structure.

4. The apparatus of claim 1, wherein:
the distal end portion comprises at least one ventral-facing contact point, at least one posterior-facing contact point, and at least one anterior-facing contact point;
wherein the at least one posterior-facing contact point and the at least one anterior-facing contact point are operatively connected to the at least one posterior-facing contact point; and
wherein resting the posterior-facing contact point on the structure causes a rotational moment created by the mass of the body, which rotational moment causes the anterior-facing contact point and the posterior-facing contact point to engage the structure.

5. The apparatus of claim 1, wherein the structure is at least one of: a slot-board, a peg-board, or the top edge of a door.

6. The apparatus of claim 1, wherein the proximal end portion comprises an elongated, rigid member extending substantially proximally from the distal end portion.

7. The apparatus of claim 1, wherein the proximal end portion is comprised of at least one of the following: a molded integral body, a portion of bend metal or plastic, or a pair of elongated thin arms.

8. The apparatus of claim 1, wherein the distal end portion comprises an aperture sized and shaped to be retained against a screw or nail.

9. The apparatus of claim 4, comprising a plurality of magnets operatively connected to a plurality of ventral-facing contact points, posterior-facing contact points, and anterior-facing contact points.

10. The apparatus of claim 1, further comprising at least one decorative cylinders disposed on the body, wherein the at least one decorative cylinder is sized and shaped to aesthetically approximate a baseball bat.

11. The apparatus of claim 1, further comprising a material disposed between a surface of the magnet and the ferrous pin, which material provides a decreased coefficient of friction between the surface of the magnet and the ferrous pin.

12. The apparatus of claim 11, wherein the material is comprised of at least one of: a polymer and a metal.

13. A display apparatus, the apparatus comprising:
a body comprising a proximal end portion and a distal end portion;
a magnet oriented on a ventrally-oriented face of the proximal end portion,
wherein the magnet is sized and shaped to magnetically retain a ferrous pin at the apex of a cap or other article;
wherein the distal end portion comprises at least one ventral-facing contact point, at least one posterior-facing contact point, and at least one anterior-facing contact point; and
wherein resting the posterior-facing contact point on a structure causes a rotational moment created by the mass of the body, which rotational moment causes the anterior-facing contact point and the posterior-facing contact point to engage the structure.

14. The apparatus of claim 13, further comprising a material disposed between a surface of the magnet and the ferrous pin, which material provides a decreased coefficient of friction between the surface of the magnet and the ferrous pin.

15. The apparatus of claim 14, wherein the material is comprised of at least one of: a polymer and a metal.

16. A display apparatus for displaying hats having a ferrous element in the apex of the hat, the apparatus comprising:
a support;
at least one magnet oriented on the support,
wherein the at least one magnet comprises a size and shape to magnetically engage the ferrous element in a hat and releasably attach the hat to the support; and
a base attached to the support,
wherein the base is configured to provide a stable platform for the support and the hat attached to the at least one magnet.

17. The apparatus of claim 16, wherein the base comprises a size and shape to be engaged upon at least one of the following: the top edge of a door, the top edge of a cubicle divider, a slot-board, a peg-board, a closet clothing rod, a tabletop, a floor, or an anchor fixed to a surface.

18. The apparatus of claim 16, further comprising at least one of a hook or a shelf configured to support a clothing item.

19. The apparatus of claim 16, further comprising a material disposed between a surface of the magnet and the ferrous element, which material provides a decreased coefficient of friction between the surface of the magnet and the ferrous element.

20. The apparatus of claim 16, wherein the material is comprised of at least one of: a polymer and a metal.
